(19) United States
(12) Patent Application Publication
(10) Pub. No.: US 2025/0290707 A1
(43) Pub. Date: Sep. 18, 2025

(54) APPARATUS, SYSTEM AND METHOD

(71) Applicant: Mixergy Limited, Oxfordshire (GB)

(72) Inventors: Peter ARMSTRONG, Oxfordshire (GB); Ben SCOTHERN, Oxfordshire (GB)

(73) Assignee: Mixergy Limited, Oxfordshire (GB)

(21) Appl. No.: 18/860,023

(22) PCT Filed: Apr. 25, 2023
(86) PCT No.: PCT/GB2023/051092

§ 371 Date: Oct. 25, 2024

(30) Foreign Application Priority Data
Apr. 25, 2022 (GB) 2206011.5
Jan. 30, 2023 (GB) 2301319.6
Feb. 6, 2023 (GB) 2301618.1

(51) Int. Cl. F28D 20/00

(52) U.S. Cl. CPC F28D 20/0039; F28D 2020/0069; F28D 2020/0078; F28D 2020/0086

(57) ABSTRACT

A thermal storage vessel for containing a heat store fluid for receiving or delivering heat and at least one heat exchanger arranged inside the vessel are provided.

The present invention relates to a thermal storage vessel for containing a heat store fluid for receiving or delivering heat.

Historically, tanks for e.g. pressurised domestic hot water supply are cylindrical and made from metallic materials. Tanks are cylindrical because it is convenient to have them operating under pressure. A pressurised tank can distribute hot water throughout a building without needing any pumps. A cylinder combined with two spherical domed ends is an efficient way to distribute stresses in a material enclosing any pressurised fluid or gas.

Cylindrical pressurised hot water tanks suffer from a number of problems.

The first problem is that to withstand the stresses associated with a pressurised tank, the internal wall of the cylinder is generally metallic. Suitable materials include:
Copper which is expensive (e.g. $9,500/ton) but can be relatively easy to work with.
Mild steel which is cheap (e.g. $1,300/ton) but generally needs to be glass lined (messy process involving furnaces and toxic materials) and can corrodes quickly;
Stainless steel which is moderately expensive ($3,200/ton) but is generally difficult to work with (e.g. requiring tungsten inert gas welding and use of pickling pastes) and contains around 22% Chromium and 5% Nickel-both materials have a high environmental impact when mined; whilst highly recyclable, stainless steel demands a considerable amount of energy to recycle.

The second problem is that cylindrical tanks made from metallic materials can be heavy and awkward to install with poor volumetric efficiency.

Such tanks typically include a cylindrical coil immersed in the tank for exchanging heat.

The present invention aims to provide improvements to such conventional tanks.

According to a first aspect there is provided a thermal storage vessel for containing a heat store fluid for receiving or delivering heat and at least one heat exchanger arranged inside the vessel, wherein the at least one heat exchanger provides conduits for two forced flows with the conduits arranged such that heat is transferred across conduit walls from one of the flows to the other flow. Immersion of a heat exchanger with two forced flows can permit particularly fine control of heat transfer and heat storage, as it is not governed by passive flows inside the tank around the heat exchanger. Immersion in the vessel can afford the advantage that heat loss at the heat exchanger is not lost to the environment but instead can be recovered in the thermal store.

For compactness the at least one heat exchanger may be a plate heat exchanger or a shell and tube heat exchanger.

For heat transfer efficiency the at least one heat exchanger may be arranged in an upper part of the thermal storage vessel, preferably at or near a top of the thermal storage vessel. Warm fluid can accumulate in the upper part of the vessel, thus enabling the material of the heat exchanger itself to store heat.

For ease of installation and maintenance the thermal storage vessel may include a body and a lid and the at least one heat exchanger is attached to the lid.

Preferably the thermal storage vessel further comprises at least one pump arranged to pump heat store fluid to the at least one heat exchanger. For compactness the at least one pump may be arranged inside the vessel. For design simplicity the pump may be a submersible pump. For cooling the pump may be arranged in a lower part of the thermal storage vessel. To improve cooling the pump may be arranged near an outlet of a discharge conduit of the pump and the discharge conduit may be arranged to discharge fluid toward the pump. To improve cooling the pump may be arranged near an inlet of a feed conduit for the pump and the feed conduit may be arranged to draw in fluid from around the pump. For versatility the pump may be a variable speed pump to adjust the flow of heat store fluid from the vessel into the heat exchanger. For reliability the pump may be arranged upstream of the heat exchanger. To improve cooling the thermal storage vessel may further comprise one or more baffles arranged above the pump. The baffle may be near the pump. The baffle is preferably beneath a location in the thermal storage vessel where heat is provided to the thermal storage vessel.

For promoting a favourable temperature distribution the thermal storage vessel may comprise a baffle or a further baffle. The baffle or further baffle may be arranged beneath the at least one heat exchanger.

For ease of installation and maintenance the thermal storage vessel may comprise one or more further components arranged inside the vessel and attached to the at least one heat exchanger, wherein an attachment between the one or more further components and the at least one heat exchanger comprises a flexible portion. Preferably the attachment is a conduit. For ease of installation and maintenance the attachment may comprise a rigid portion for arrangement in a lower part of the thermal storage vessel and the flexible portion for arrangement in an upper part of the thermal storage vessel. For ease of access the flexible portion may be for arrangement at and/or beneath the at least one heat exchanger. In an extended configuration of the flexible portion the at least one heat exchanger may be removable from the thermal storage vessel without moving the one or more further components. For ease of assembly the or a rigid portion of the attachment may be rigidly attached to one or more of the further components. The rigid portion of the attachment and the one or more of the further components are preferably for arrangement in a lower part of the thermal storage vessel. The rigid portion of the attachment and the one or more of the further components may be for resting on a floor of the thermal storage vessel. The one or more further components may be at least one of: a pump, a diffuser, and a baffle.

For ease of manufacture the thermal storage vessel or a body of the thermal storage vessel may be formed of a polymer.

For space efficiency the thermal storage vessel may be cuboid or trapezoidal.

The heat store fluid is preferably water or an aqueous solution.

For measuring heat stored the thermal storage vessel may further comprise an array of temperature sensors arranged to sense temperatures at different heights in the vessel.

For ease of manufacture the thermal storage vessel may be for containing heat store fluid at ambient pressure. Preferably the thermal storage vessel is a vented thermal storage vessel.

The thermal storage vessel may comprise a first and a second heat exchanger. The first heat exchanger may be for receiving heat at the thermal storage vessel from an external heat source.

The second heat exchanger may be for delivering heat from the thermal storage vessel to an external fluid circuit. The external heat source may be a heat pump or a solar heating system. The external fluid circuit may be a circuit of mains pressurized water or a circuit of fluid for a space heating system.

For ease of maintenance the thermal storage vessel may further comprise at least one tab arranged to protrude in a first configuration and withdraw in a second configuration and further arranged to support the at least one heat exchanger relative to the thermal storage vessel in the first configuration and to release the at least one heat exchanger relative to the thermal storage vessel in the second configuration. At least one tab may be pivotably attached at an underside of the at least one heat exchanger. At least one tab may be pivotably attached at a rim of the thermal storage vessel. Preferably 3 or more tabs are provided.

The at least one heat exchanger may be for receiving heat from an external heat source; and a conduit for providing heat store fluid to the at least one heat exchanger may be arranged to draw fluid from a lower portion of the thermal storage vessel.

The at least one heat exchanger may be for receiving heat from an external heat source; and a conduit for providing heat store fluid to the at least one heat exchanger may include a first branch arranged to draw fluid from a lower portion of the thermal storage vessel and a second branch arranged to draw fluid from an upper portion of the thermal storage vessel. The thermal storage vessel may further comprise a first pump in the first branch and a second pump in the second branch. The thermal storage vessel may further comprise a non-return valve in each branch. The thermal storage vessel may further comprise a valve at the junction of the first and second branch for selection of the first or second branch.

The at least one heat exchanger is for receiving heat from an external heat source; and a conduit for returning heat store fluid from the at least one heat exchanger may be arranged to release fluid in an upper or central portion of the thermal storage vessel.

The at least one heat exchanger may be for receiving heat from an external heat source; and the thermal storage vessel may further comprise a diverter valve arranged to provide a flow path from the heat exchanger either to an upper portion of the thermal storage vessel or to a central or lower portion of the thermal storage vessel.

The at least one heat exchanger may be for delivering heat from the thermal storage vessel to an external fluid circuit; and a conduit for providing heat store fluid to the at least one heat exchanger may be arranged to draw fluid from an upper portion of the thermal storage vessel.

The at least one heat exchanger is for delivering heat from the thermal storage vessel to an external fluid circuit; and a conduit for returning heat store fluid from the at least one heat exchanger may be arranged to release fluid in a lower portion of the thermal storage vessel.

For controlling heat distribution the thermal storage vessel may further comprise a top-up system including an electric heating element arranged in an upper part of the thermal storage vessel, a pump and a conduit arranged to draw heat store fluid from a lower part of the thermal storage vessel to the electric heating element. The pump may be as aforementioned. The conduit may be as aforementioned.

The thermal storage vessel may further comprise a heat store fluid supply conduit for providing heat store fluid into the thermal storage vessel and a float valve arranged to close the heat store fluid supply conduit at a predetermined vessel fill level.

According to another aspect there is provided a heating system comprising a thermal storage vessel as aforementioned. The heating system may further comprise one or more of: a controller arranged to control the components of the heating system including the components of the thermal storage vessel; a heat source, preferably a heat pump, arranged to deliver or receive heat to or from the thermal storage vessel; a diverter valve for diverting heat from the heat source to the thermal storage vessel or from the thermal storage vessel to another subsystem; a circuit of mains pressurized water arranged to receive heat from the thermal storage vessel; and a space heating system with a circuit of fluid arranged to receive heat from the thermal storage vessel.

According to another aspect there is provided a kit of parts for a thermal storage vessel for containing a heat store fluid for receiving or delivering heat, the kit including a body and a lid; and at least one heat exchanger for arrangement inside the vessel, with the heat exchanger having conduits for two forced flows with the conduits arranged such that heat is transferred across conduit walls from one of the flows to the other flow, for arrangement of the heat exchanger inside the vessel. The kit of parts may be for a thermal storage vessel as aforementioned.

According to another aspect there is provided a method of heating fluid comprising providing the fluid to a thermal storage vessel as aforementioned.

According to another aspect there is provided a thermal storage vessel for containing a heat store fluid for receiving or delivering heat, and at least one heat exchanger. The thermal storage vessel preferably includes a body and a lid. The at least one heat exchanger is preferably attached to the lid for arrangement of the heat exchanger inside the thermal storage vessel.

By providing the at least one heat exchanger attached to the lid for arrangement of the heat exchanger inside the thermal storage vessel a number of benefits can be provided including ease of transport, installation and maintenance as well as performance enhancements.

Preferably the at least one heat exchanger is attached to the lid for arrangement of the heat exchanger in an upper part of the thermal storage vessel. Alternatively the at least one heat exchanger is attached to the body for arrangement of the heat exchanger in an upper part of the thermal storage vessel. The at least one heat exchanger may be attached to the body at a rim of the body.

Preferably the at least one heat exchanger is arranged in an upper part of the thermal storage vessel. The at least one heat exchanger is preferably a plate heat exchanger.

For cost and weight advantages the body and optionally the lid may be formed of a polymer. For strength the lid may include one or more metal portions. For space efficiency the thermal storage vessel may be cuboid or trapezoidal.

The thermal storage vessel may further comprise a temperature reducing valve. The temperature reducing valve may provide a connection bypassing the heat exchanger in the thermal storage vessel for reducing the temperature by mixing unheated fluid with heated fluid flowing out of the heat exchanger.

The heat store fluid is preferably water or an aqueous solution. The thermal storage vessel may further comprise a phase change material, preferably one or more compartments containing a phase change material. The thermal storage vessel is preferably for containing an unpressurised heat store fluid.

For ease of maintenance and assembly the thermal storage vessel may further comprise a submersible pump (optionally attached to the lid) for arrangement inside the vessel, with the submersible pump arranged to pump heat store fluid from the vessel into the heat exchanger. The submersible pump may be attached to the lid via the at least one heat exchanger attached to the lid. The submersible pump is preferably a variable speed pump to adjust the flow of heat store fluid from the vessel into the heat exchanger.

The submersible pump is preferably for arrangement in a lower part of the thermal storage vessel. A conduit associated with the submersible pump may be arranged to discharge fluid toward the submersible pump or draw in fluid from around the submersible pump. The submersible pump may be arranged near an outlet of a discharge conduit downstream of the submersible pump. The discharge conduit may be arranged to discharge fluid toward the submersible pump. The submersible pump may be arranged near an inlet of a feed conduit upstream of the submersible pump. The feed conduit may be arranged to draw in fluid from around the submersible pump. For efficient operation the submersible pump is preferably arranged upstream of the heat exchanger.

For promoting stratification the thermal storage vessel may further comprise one or more baffles arranged above the submersible pump and preferably beneath a location in the thermal storage vessel where heat is provided to the thermal storage vessel.

For ease of maintenance and assembly the thermal storage vessel may further comprise a diffuser (optionally attached to the lid) for arrangement inside the vessel, with the diffuser arranged to diffuse heat store fluid from the heat exchanger into the vessel. The diffuser may be attached to the lid via the at least one heat exchanger attached to the lid.

The thermal storage vessel may comprise a first and a second heat exchanger, wherein the first heat exchanger is for receiving heat at the thermal storage vessel from an external heat source; and the second heat exchanger is for delivering heat from the thermal storage vessel to an external fluid circuit. The external heat source may be a heat pump and/or the external fluid circuit may be a circuit of mains pressurized water.

For versatility the thermal storage vessel may further comprise a top-up system including an electric heating element arranged in an upper part of the thermal storage vessel, a pump and a conduit arranged to draw heat store fluid from a lower part of the thermal storage vessel to the electric heating element. The electric heating element is optionally attached to the lid for arrangement inside the thermal storage vessel. The conduit and the pump may be attached to the lid for arrangement inside the thermal storage vessel. The pump may be a submersible pump. The submersible pump is preferably arranged in a lower part of the thermal storage vessel. A conduit may be arranged to discharge fluid toward the submersible pump or draw in fluid from around the submersible pump. The top-up system may further comprise a diffuser arranged to diffuse heat store fluid discharged from the conduit.

For ease of operation the thermal storage vessel may further comprise a heat store fluid supply conduit for providing heat store fluid into the thermal storage vessel and a float valve arranged to close the heat store fluid supply conduit at a predetermined vessel fill level.

For ease of control the thermal storage vessel may further comprise an array of temperature sensors arranged to sense temperatures at different heights in the vessel.

For versatility the first heat exchanger may be for receiving heat from an external heat source; and may further comprise a diverter valve arranged to provide a flow path from the first heat exchanger either to an upper portion of the thermal storage vessel or to a lower portion of the thermal storage vessel.

Preferably the thermal storage vessel is a vented thermal storage vessel. Preferably the thermal storage vessel is for containing fluid at ambient pressure.

According to another aspect there is provided a heating system comprising a thermal storage vessel as aforementioned.

The heating system may further comprise one or more of:
a controller arranged to control the components of the heating system including the components of the thermal storage vessel;
a heat source, preferably a heat pump, arranged to deliver or receive heat to or from the thermal storage vessel;
a diverter valve for diverting heat from the heat source to the thermal storage vessel or from the thermal storage vessel to another subsystem; and
a circuit of mains pressurized water arranged to receive heat from the thermal storage vessel.

The controller may be adapted to control a pump speed of a variable speed pump in dependence on a heat availability and a heat demand. The controller may be adapted to select a greater pump speed to for rapid heat transfer or a lower pump speed for high efficiency heat transfer. The controller may be adapted to control a pump speed of a variable speed pump in dependence on a sensed temperature in the thermal storage vessel. The controller may be adapted to control a pump speed so as to maintain a target temperature of heat store fluid flowing out from the heat exchanger. A minimum pump speed may be determined by the controller so as to maintain a minimum temperature of heat store fluid flowing out from the heat exchanger.

According to another aspect there is provided a kit of parts for a thermal storage vessel for containing a heat store fluid for receiving or delivering heat, the kit including a body and a lid; and at least one heat exchanger, preferably for attachment to the lid for arrangement of the heat exchanger inside the vessel. The parts may be for a thermal storage vessel as aforementioned.

According to another aspect there is provided method of heating fluid comprising providing the fluid to a thermal storage vessel as aforementioned.

According to another aspect there is provided a controller for controlling a thermal storage vessel as aforementioned. The controller may control one or more pumps in dependence on one or more temperature sensors.

According to another aspect there is provided a thermal storage vessel for containing a heat store fluid for receiving or delivering heat, and at least one heat exchanger.

The at least one heat exchanger may:
be arranged inside the vessel;
provide conduits for two forced flows with the conduits arranged such that heat is transferred across conduit walls from one of the flows to the other flow;
be attached to a lid of the thermal storage vessel;
be arranged in an upper part of the thermal storage vessel; and/or
be as aforementioned.

The thermal storage vessel may:
comprise a body and a lid
be formed of a polymer
be cuboid or trapezoidal;
be as aforementioned; and/or
comprise components as aforementioned.

According to another aspect there is provided a vented thermal storage vessel. The vessel can have a cuboidal form factor. Peripheral componentry associated with heat transfer can be integrated within a top access lid of the vessel. This can enable ease of maintenance whilst splitting the mass of the product to simplify installation. The vented thermal storage vessel can eliminate many of the challenges around conventional cylindrical tanks (weight, poor volumetric efficiency, material intensity/cost).

Provision of the lid can facilitate servicing peripheral parts (such as pressure reducing valves and expansion vessels), which otherwise typically require an installation engineer to drain down the entire system which is time consuming.

The cuboidal form factor can enable greater volumetric efficiency, in particular compared to conventional cylindrical tanks. Volumetric efficiency can be especially beneficial for domestic installations where space may not be abundantly available, in particular when a heating system is retrofitted to a building. For instance installation of a low carbon energy input such as a heat-pump system can require installation of a thermal storage vessel.

Preferably one or more plate heat exchangers are provided housed internally within the thermal storage vessel. Providing plate heat exchangers can facilitate heat transfer. Preferably peripheral equipment is provided housed internally within the thermal storage vessel. Peripheral equipment may include:
one or more pumps;
at least one state of charge sensor;
inlet/outlet connections; and/or
one or more temperature sensors.

According to another aspect there is provided a thermal store wherein an access lid assembly is provided which incorporates a plate heat exchanger disposed internally within the thermal store alongside an associated submersible heat transfer pump which enables transfer of energy between the stored hot water and potable water supply alongside an electric heating element alongside a fill ball cock. Preferably an additional indirect plate heat exchanger is also incorporated within the lid to facilitate heat transfer to and from an indirect energy source and the stored water inside. Preferably a return diffuser is integrated in the return path from the indirect plate heat exchanger and integrated within the lid assembly. Preferably a top-up system is incorporated within the lid assembly. Preferably a sensor is incorporated within the lid assembly. Preferably an addressable sensor comprising shift registers is provided.

Any apparatus feature as described herein may also be provided as a method feature, and vice versa.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

As used herein, means plus function features may be expressed alternatively in terms of their corresponding structure, such as a suitably programmed processor and associated memory.

As used herein, the term ‘vented’ preferably refers to a vessel that is not designed to operate containing a pressurised fluid, and the term ‘unvented’ preferably refers to a vessel that is designed to operate containing a pressurised fluid.

As used herein, the term ‘thermal storage vessel’ preferably refers to a vessel for storing thermal energy by heating fluid contained in the vessel. The fluid is preferably water. The fluid is preferably not pressurised.

As used herein, the term ‘thermal store’ is also used to refer to a thermal storage vessel.

As used herein, the term ‘an upper part’ of a vessel preferably refers to an upper half, an upper third, an upper quarter, an upper fifth or an upper tenth of the vessel (by volume or by height), with the vessel in such orientation as it is intended to be installed for use.

As used herein the terms ‘heat’ and ‘thermal energy’ are interchangeable.

These and other aspects of the present invention will become apparent from the following exemplary embodiments that are described with reference to the following figures in which:

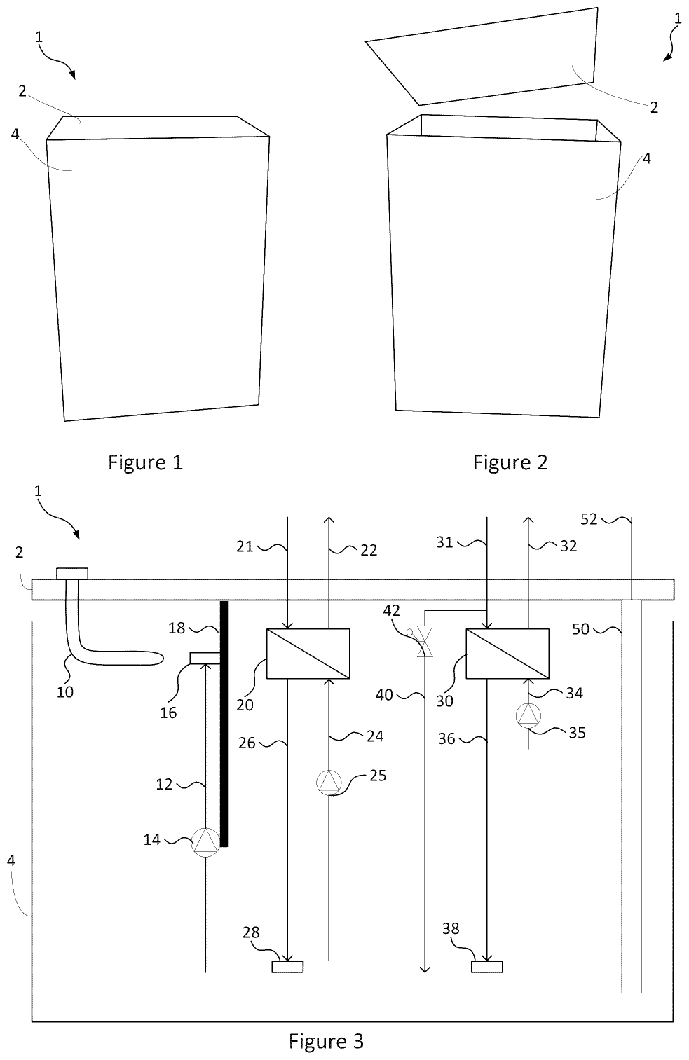

FIG. 1 is a schematic of a thermal storage vessel;

FIG. 2 is a schematic of the thermal storage vessel of FIG. 1 in different configuration;

FIG. 3 is a schematic of a thermal storage vessel with peripheral equipment;

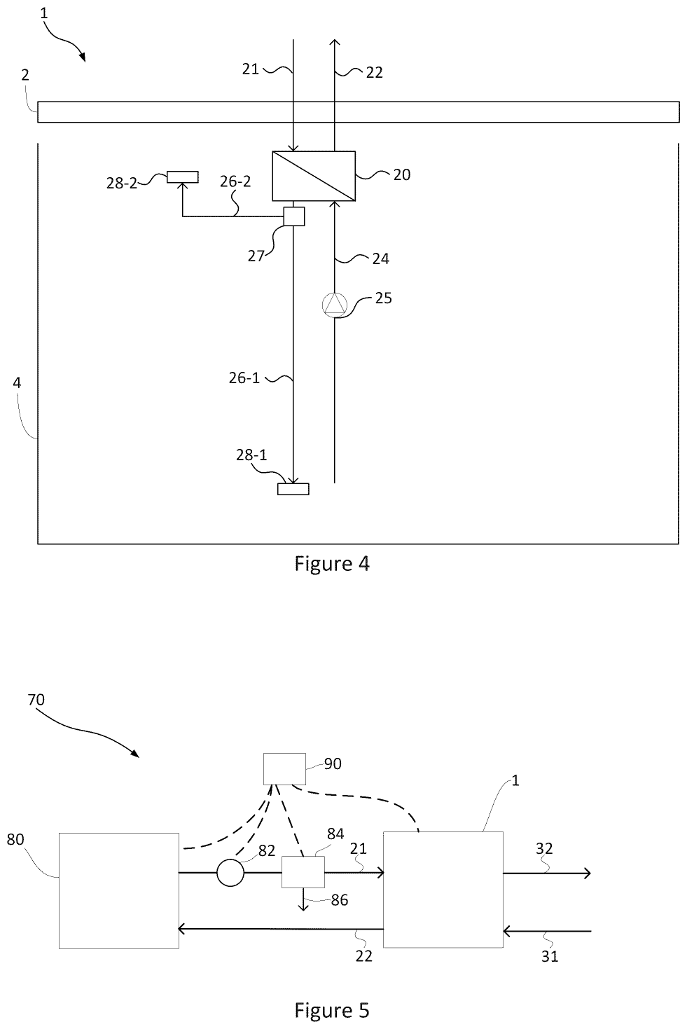

FIG. 4 is a schematic of a variant in a thermal storage vessel;

FIG. 5 is a schematic of a heating system with a thermal storage vessel;

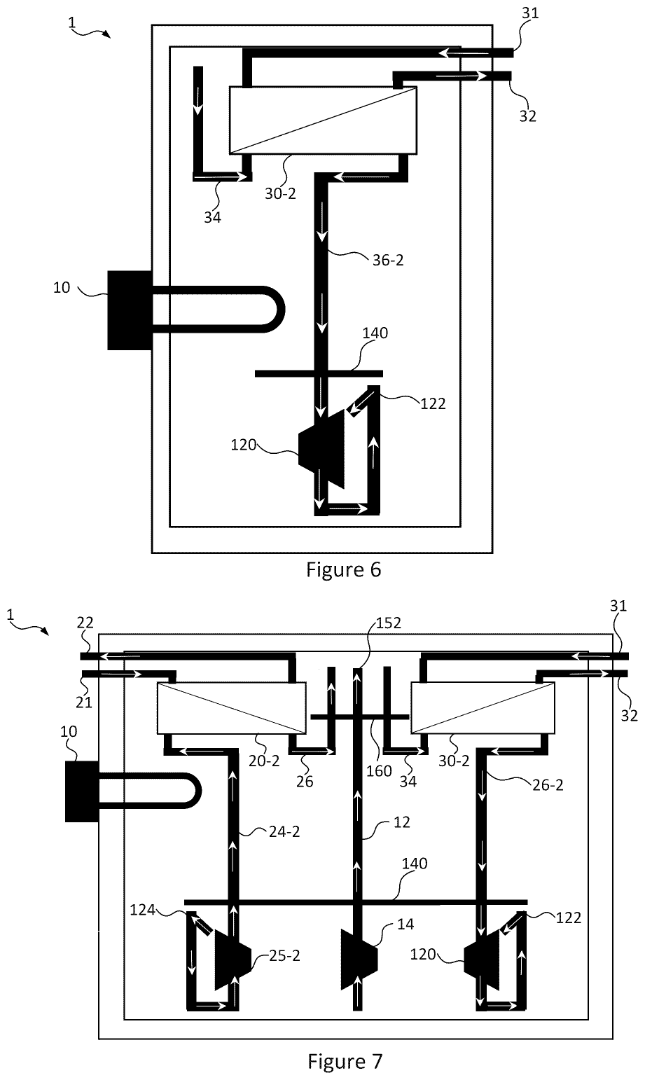

FIG. 6 is a schematic of a variant in a thermal storage vessel;

FIG. 7 is a schematic of a variant in a thermal storage vessel;

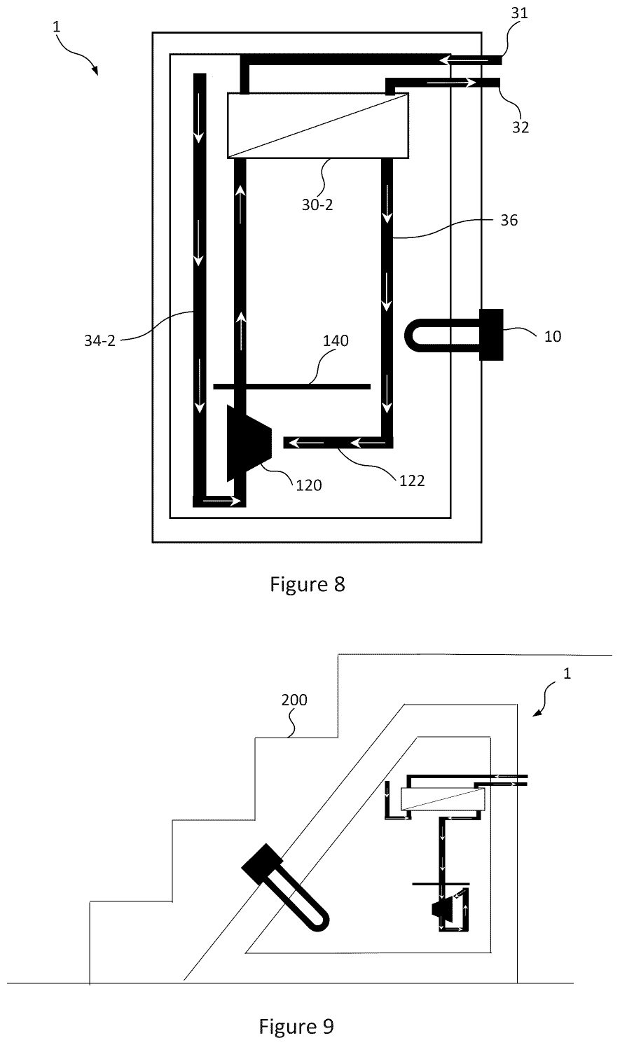

FIG. 8 is a schematic of a variant in a thermal storage vessel;

FIG. 9 is a schematic of a trapezoidal thermal storage vessel;

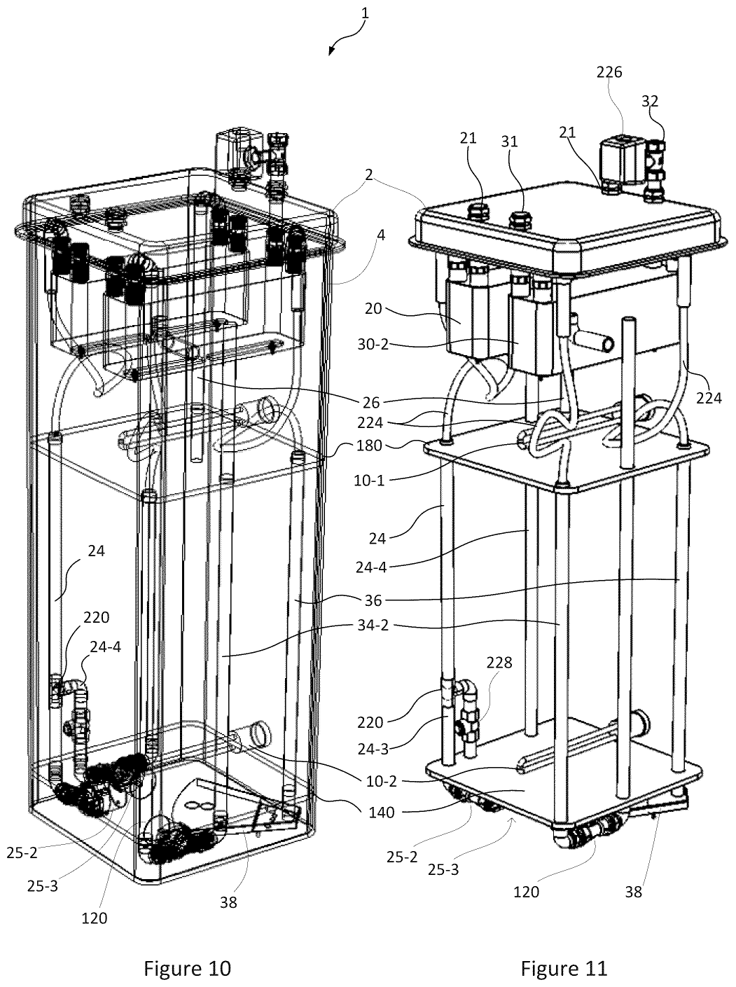

FIG. 10 is an illustration of another thermal storage vessel;

FIG. 11 is an illustration of a lid and internal components of the thermal storage vessel of FIG. 10;

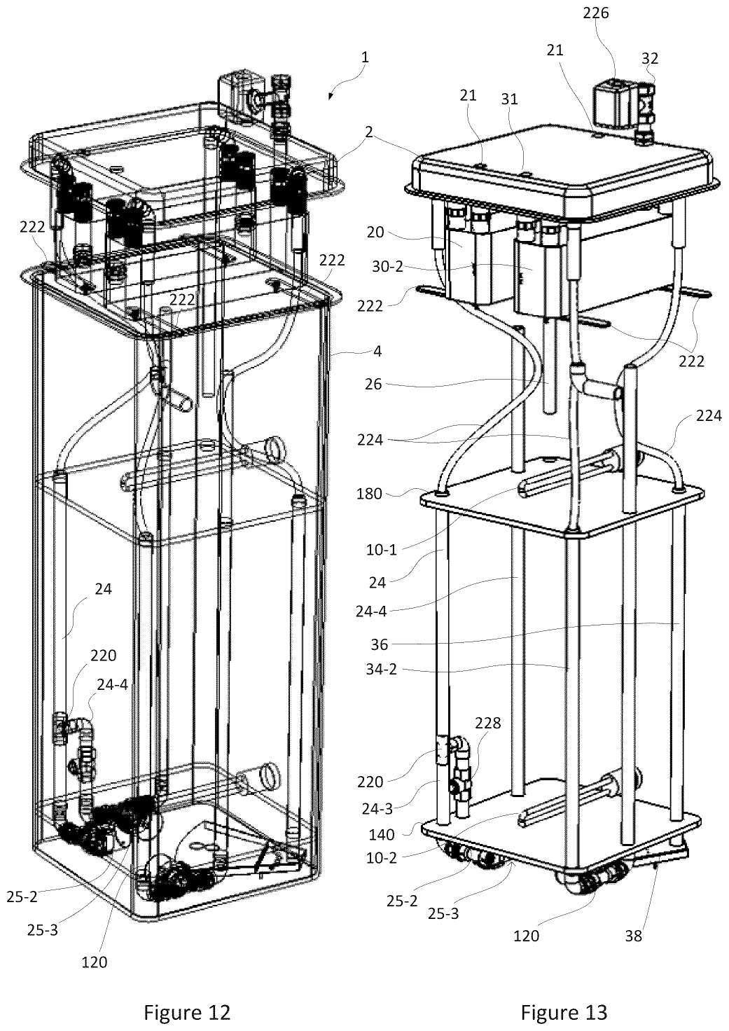

FIG. 12 is an illustration of the thermal storage vessel of FIG. 10 in an open configuration;

FIG. 13 is an illustration of a lid and internal components of the thermal storage vessel of FIG. 12;

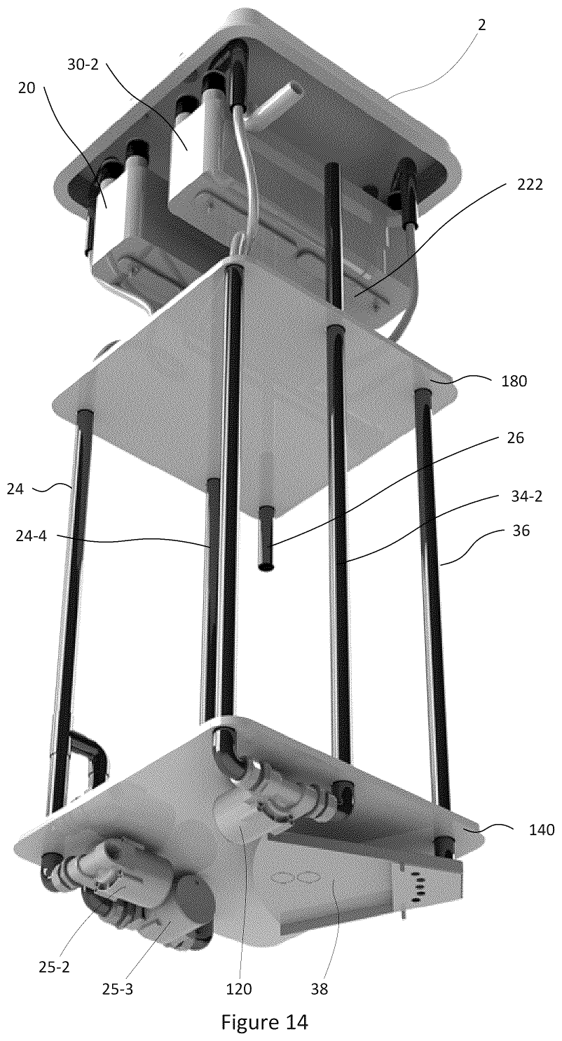

FIG. 14 is an illustration of the lid and internal components of FIG. 11 from another perspective;

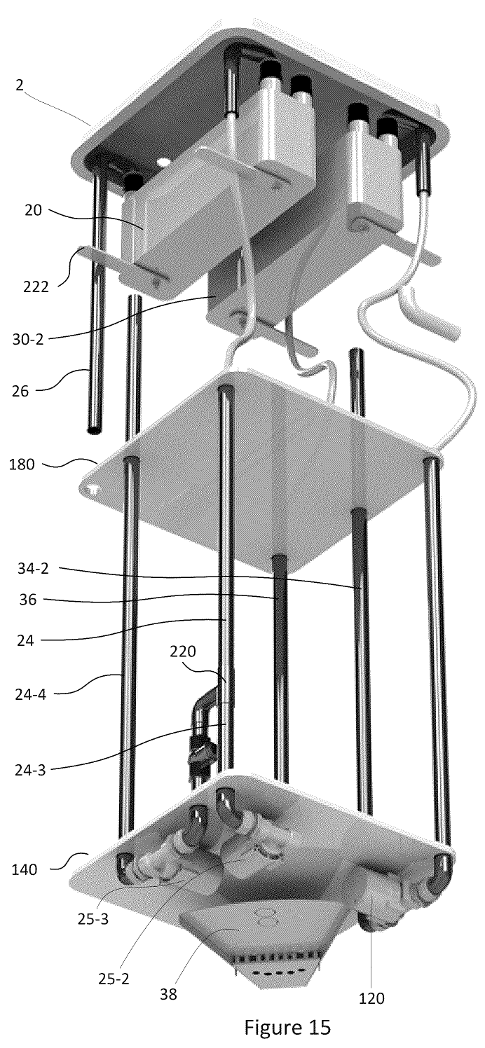

FIG. 15 is an illustration of the lid and internal components of FIG. 13 from another perspective;

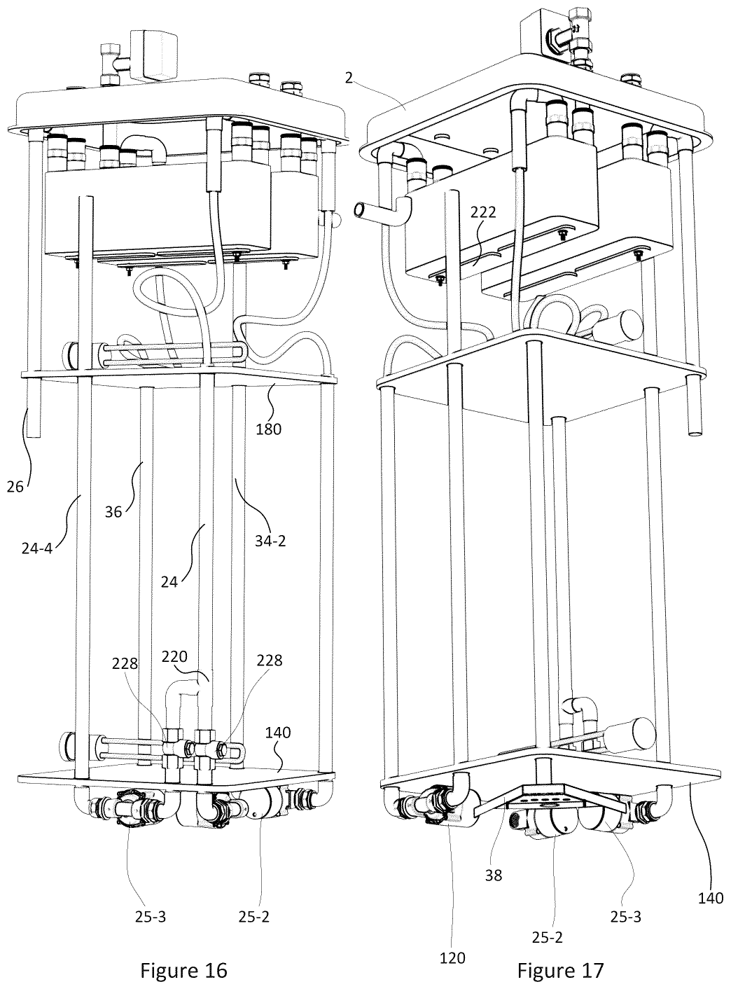

FIG. 16 is an illustration of the lid and internal components of FIG. 11 with additional features; and

FIG. 17 is an illustration of the lid and internal components of FIG. 16 from another perspective.

FIG. 1 shows a thermal storage vessel 1 that is formed of a body 4 and a lid 2. The lid 2 is removably attached to the body 4. The lid 2 forms a seal with the body 4 to contain fluid in the vessel 1. FIG. 2 shows the body 4 and the lid 2 in a configuration with the lid 2 detached from the body 4. A wide variety of means for removably attaching the lid to the body can be used, and generally permit detachment and re-attachment without substantial damage to the body or the lid.

The thermal store 1 serves to transfer thermal energy into and out of the heat store fluid contained by the vessel. Potable water and/or central heating fluid is isolated from the fluid inside the thermal storage vessel. The vessel is vented, as the heat store fluid need not be pressurised.

For installation, the body 4 and the lid 2 can be separated and transported separately. For a vessel sized for typical domestic use this can enable a single person to lift the separate parts and install the vessel, instead of a team of several persons.

In the illustrated examples the vessel is cuboid with 6 relatively flat surfaces. This can permit the vessel to be installed in cuboid spaces such as cupboards and corners of rooms, and to make optimal use of such spaces.

The body is preferably of a polymer such as a polyethylene (also referred to as polyethene). A polymer can be relatively cheap, light and highly recyclable with lower energy costs for recycling. The body can include a number of polymers, for instance a structural polymer for strength of the vessel and an insulation polymer for thermal insulation of the fluid held in the vessel. Fabrication of the body out of a polymer can be relatively cheap, for example by roto-moulding a structural polyethylene inner shell and attaching insulation foam polymer panels onto the shell. The body being of a polymer can enable it to be relatively light and a single person may be able to lift the body for installation of the vessel, instead of a team of several persons.

The lid may be of a polymer similar to the body to afford similar advantages. As the lid is generally smaller than the body and the weight is less critical, it may be acceptable to include heavier materials such as metal portions in the lid to afford other advantages, such as structural rigidity. In an example the lid is of a composite material including both a polymer and folded metal struts to give the lid additional strength for attaching components to the lid.

In some examples the body 4 may be provided in separate sub-parts that can be transported separately and assembled on site to form the body 4.

FIG. 3 shows the thermal storage vessel 1 with a number of components attached to the lid 2.

A first heat exchanger 20 is attached to the lid 2 for arrangement of the heat exchanger 20 inside the vessel 1. In the illustrated example the first heat exchanger 20 is for receiving heat from an external source, such as a heat pump, a solar panel or a boiler. The heat exchanger 20 is a plate heat exchanger with an inlet conduit 21 for the external heat source fluid and an outlet conduit 22 for the external heat source fluid; and an inlet conduit 24 for the heat store fluid and an outlet conduit 26 for the heat store fluid. A first submersible pump 25 is provided to pump heat store fluid to the first heat exchanger 20.

Conventionally plate heat exchangers are provided external to vessels, but it has been recognised that providing a heat exchanger inside the vessel can be beneficial. A plate heat exchanger provided externally is maintained at ambient temperature, and can present a heat loss as heat from an external heat source is received. Providing a heat exchanger inside the vessel can permit the heat exchanger to form part of the thermal capacity of the heat store. Heat losses can be minimised. By providing a heat exchanger in an upper part of the vessel, a relatively high temperature at the heat exchanger can be maintained, higher than the ambient temperature, which can permit particularly effective heat transfer. Thermal lag can be reduced when the heat transfer is switched on after a dormant period.

By providing the heat exchanger inside the vessel the envelope of the system can be minimised and be more compact to make optimal use of an available space.

For attaching the first heat exchanger 20 to the lid 2 fixing the inlet conduit 21 and/or outlet conduit 22 for the external heat source fluid to the lid may be sufficient. Alternatively or additionally brackets or other attachment mechanisms may be included. The first heat exchanger 20 can be rigidly attached to the lid 2, or it may be attached such that a degree of movement between the first heat exchanger 20 and the lid 2 is possible.

By attaching the heat exchanger 20 to the lid 2 a number of advantages can be achieved. For installation, the heat exchanger 20 and the lid 2 can be provided as a pre-assembled unit, affording ease of on-site assembly and installation. The pre-assembled lid can simply be mounted onto the body 4 and suitably attached. This can be particularly effective with additional components included in the lid.

For maintenance, the heat exchanger 20 can be accessed particularly easily by lifting the lid 2 from the vessel. This can permit particularly convenient maintenance. Also, the vessel need not be drained, or need only be partially drained, which is more convenient for the engineer and also can prevent excessive use of heat store fluid (e.g. additives to an aqueous heat store fluid). Components associated with the heat exchanger 20 (such as conduits, pump, diffuser) can remain attached to the heat exchanger 202 (and/or the lid 2) and need not be detached and re-attached for ease of maintenance.

To extend the advantages to further components in the heating system, the example shown in FIG. 3 includes further components attached to the lid 2 for arrangement of the components inside the vessel 1.

The first submersible pump 25 is arranged to pump heat store fluid from the vessel into the first heat exchanger 20. The first submersible pump 25 may be an electric submersible pump. In other examples the pump is provided outside the vessel, but by providing it inside the vessel similar advantages can be achieved as described above with reference to the first heat exchanger 20. For attaching the first submersible pump 25 to the lid 2 an attachment to the first heat exchanger 20 may be provided, e.g. by the inlet conduit 24 (or the outlet conduit 26) for the heat store fluid (for example in case of a sufficiently robust pipe or tube), or additional brackets or other attachment mechanisms may be included attaching the submersible pump 25 directly to the lid 2 or attaching the submersible pump 25 to the first heat exchanger 20 and hence indirectly to the lid 2.

A first diffuser 28 is arranged at the end of the outlet conduit 26 from the heat exchanger 20, where the heat store fluid is returned from the heat exchanger back to the body of heat store fluid in the vessel. The first diffuser 28 is such that the fluid is diffused gently back into the vessel so as to avoid fluid flows that could cause excessive mixing of thermal stratification of heat store fluid in the vessel. In the illustration the first diffuser 28 is provided in a lower part of the vessel. Returning fluid at an elevated temperature to the bottom of the vessel can potentially cause undesired mixing, so in some examples the first diffuser 28 is provided elsewhere than the bottom of the vessel to promote thermal stratification. In some examples a device is included that can enable diffusion of fluid back into the vessel at a variable height, depending on the temperature of the fluid. This can be particularly effective in preventing unintended mixing of thermally stratified heat store fluid in the vessel.

The first diffuser 28 is conveniently attached to the first heat exchanger 20 and hence to the lid 2 by the outlet conduit 26 (for example in the form of a sufficiently robust pipe or tube). Additional brackets or other attachment mechanisms may be included attaching the first diffuser 28 directly to the lid 2 or attaching the first diffuser 28 to the first heat exchanger 20 and hence indirectly to the lid 2.

The inlet conduit 24 to the first heat exchanger 20 is arranged to draw heat store fluid from a lower part of the vessel. This is to ensure that in a thermally stratified vessel of heat store fluid cool fluid is drawn, if available, in order to receive heat from an external source. The inlet conduit 24 may include features to draw in fluid smoothly.

A second heat exchanger 30 is attached to the lid 2 for arrangement of the heat exchanger 30 inside the vessel 1. The second heat exchanger 30 has many features in common with the first heat exchanger 20, and it will be understood that these may be provided analogous as described above. In the illustrated example the second heat exchanger 30 is for providing heat from the heat store to an external fluid circuit, such as a potable water circuit. The heat exchanger 30 is a plate heat exchanger with an inlet conduit 31 for the external fluid circuit and an outlet conduit 32 for the fluid circuit; and an inlet conduit 34 for the heat store fluid and an outlet conduit 36 for the heat store fluid. A second submersible pump 35 is provided to pump heat store fluid to the second heat exchanger 30. A second diffuser 38 is provided at the end of the outlet conduit 36 for diffusing fluid back. The inlet conduit 34 to the second heat exchanger 30 is arranged to draw heat store fluid from an upper part of the vessel. This is to ensure that in a thermally stratified vessel of heat store fluid hot fluid is drawn in order to provide heat from the heat store to an external fluid circuit.

A fluid supply conduit 40 is attached to the lid 2 for replenishing heat store fluid in the vessel. In the illustrated example the fluid supply conduit branches out of a potable water circuit at the inlet conduit 31 for the external fluid circuit, between the lid 2 and the second heat exchanger 30. A float valve 42 is arranged in the fluid supply conduit 40 to close the fluid supply conduit at a vessel fill level. Such a valve can ensure that the fluid in the vessel is replenished up when the level drops below a threshold, and that the vessel is not filled beyond a threshold.

A top up sub-system includes a conduit 12 is attached to the lid 2 for providing heat store fluid from a lower portion of the vessel to an upper portion of the vessel. A bracket 18 is included for attaching the conduit 12 to the lid 2. A third submersible pump 14 is provided to pump heat store fluid in the conduit 12. The conduit 12 is arranged to draw heat store fluid from a lower part of the vessel. This is to ensure that in a thermally stratified vessel of heat store fluid cold fluid is drawn. The conduit 12 is arranged to discharge heat store fluid in proximity to an electric heating element 10, preferably in an upper part of the vessel. By switching on the electric heating element 10 and the third submersible pump 14, an on-demand portion of heat can be provided to the thermal storage vessel 1 and thus to a user. This can enable on-demand topping up of heating availability quickly and without relying on an external source, such as a heat pump, a solar panel or a boiler, which may not be able to provide heat immediately. A diffuser 16 is arranged to diffuse heat store fluid at the outlet of the conduit 12 so as to enable efficient heating by the electric heating element 10. In an example the electric heating element 10 is a direct electric immersion heater.

An array of temperature sensors 50 is attached to the lid 2 to sense temperatures at different heights in the vessel. A wire 52 is illustrated from the array of temperature sensors 50 to connect to other components. The array of temperature sensors 50 can permit detection of the state of thermal stratification of heat store fluid in the vessel, which can give an indication of the heat available for use from the thermal store, depending on the thermal profile.

Suitable connections are provided via the lid 2 for the components described above, for instance for power and control signals to the components and data from the components.

In the thermal storage vessel 1 described above with reference to FIG. 3 a number of components are described attached to the lid 2 for arrangement inside the vessel 1, but it should be appreciated that many of these components can be provided in in other arrangements, whether or not attached to the lid and whether arranged inside or outside the vessel; many of the advantages afforded by the thermal storage vessel 1 can still be provided with some of the components provided elsewise than described above, or omitted altogether. For example, one or more of the pumps may be provided mounted external to the lid. The top-up system may be omitted. The conduit and pump of the top-up system may be attached elsewhere, for example to the body 4 of the vessel. The first heat exchanger 20 may be provided outside the vessel, and only the second heat exchanger 30 is provided in the vessel.

FIG. 4 is a schematic of a variant for the sub-system including the first heat exchanger 20. Generally like features are indicated with like reference numbers. Only the sub-system including the first heat exchanger 20 is illustrated, but it should be understood that the other features described with reference to FIG. 3 may be included.

In the variant shown in FIG. 4, instead of a simple outlet conduit 26 from the first heat exchanger 20 an outlet conduit with two branches 26-1, 26-2 is provided. A diverter valve 27 is provided at the branching point and can be controlled to divert fluid exiting from the heat exchanger 20 to either a first branch 26-1 or to a second branch 26-2. At the end of each branch 26-1, 26-2 a diffuser 28-1, 28-2 is provided. The first branch 26-1 of the outlet conduit is arranged to return the heat store fluid from the heat exchanger back to the body of heat store fluid in the vessel at a lower part of the vessel. The second branch 26-2 of the outlet conduit is arranged to return the heat store fluid to an upper part of the vessel. The height of the outlet of the second branch 26-2 can be selected such that a suitable portion of the vessel is heated for immediate use scenarios. The diverter valve 27 may be a three-port valve such as an L-port ball valve that is electronically controllable. The diverter valve 27 may be a passive valve that can be controlled otherwise, e.g. by temperature or by selection of a flow speed by way of a variable speed pump as the first submersible pump 25.

This arrangement can permit heated heat store fluid either: to return to the bottom of the vessel for efficiently heating the vessel gradually; or to be diverted to an upper portion of the vessel. Low temperature heat sources such as heat pumps can take a considerable length of time—often several hours—to heat a thermal storage vessel 1 to an appropriate temperature. On the other hand it can be desirable to heat only a portion of fluid for immediate use quickly, e.g. when a user has decided that they need it. By providing an outlet conduit with two branches 26-1, 26-2 and diverting fluid into either one or the other different use scenarios can be accommodated. Once a quantity of fluid is heated at the top of the vessel for immediate use, gradual heating of the remaining fluid can be resumed without disturbing the immediately available hot fluid at the top of the vessel.

A controller (not shown) can control the diverter valve 27 and select a flow path depending on hot water demand.

FIG. 5 is a schematic of a heating system 70 with a thermal storage vessel 1. An external heat source 80, such as a heat pump, provides heated fluid from the external heat source 80 to the thermal storage vessel 1. A pump 82 pumps the heated fluid to the inlet conduit 21 of the first heat exchanger 20 of the thermal storage vessel 1, and the fluid is returned via the outlet conduit 22 of the first heat exchanger 20 back to the external heat source 80. A diverter valve 84 can be actuated to divert heated fluid from the external heat source 80 to another fluid circuit 86, for example to a space heating circuit with radiators (not shown). Mains pressurised water is provided to the inlet conduit 31 of the second heat exchanger 30 of the thermal storage vessel 1, and returned via the outlet conduit 32 of the second heat exchanger 30 back to the potable water circuit, for instance for domestic hot water supply.

A controller 90 controls operation of the external heat source 80 (indicated with dashed lines in the schematic), the pump 82 and the diverter valve 84. The controller 90 also controls operation of the thermal storage vessel 1, in particular switching on and off:
the first submersible pump 25;
a diverter valve 27, if included;
the second submersible pump 35;
the third submersible pump 14; and
the electric heating element 10.

The controller 90 can also receive data from the array of temperature sensors 50 and control the operation of the heating system depending on that data. For example, if the thermal storage vessel 1 is not fully heated then the controller 90 can cause heat to be provided from the external heat source 80 to the thermal storage vessel 1 rather than switching the external heat source off for a period. If the thermal storage vessel 1 is not sufficiently heated for a user hot water demand then the controller 90 can cause heat to be provided to the thermal storage vessel 1 with the electric heating element 10 and the third submersible pump 14 in a topping up mode.

The controller 90 can also cause heat to be provided to the thermal storage vessel 1 with the electric heating element 10 and the third submersible pump 14 in a topping up mode.

The heating system can also be operated to provide heat from the thermal storage vessel 1 to the external heat source 80 or elsewhere. This can be beneficial for instance for a defrosting cycle of a heat pump prior to its operation as a heat source; or to provide heat from the thermal storage vessel 1 to a space heating circuit with radiators while the heat pump is switched off for a period. This can enable reducing on/off cycling of the heat pump as a dwelling is heated around its particular control set point temperature and hysteresis margin.

FIG. 6 shows a schematic of another exemplary embodiment of the thermal storage vessel 1. White arrows denote the direction of fluid flow within the vessel and/or associated conduits. A variant of the second heat exchanger 30 is provided for transferring heat from the heat store to an external fluid circuit, such as a potable water circuit. The second heat exchanger 30-2 has many features in common with the heat exchanger 30, and it will be understood that these may be provided analogous as described above. The second heat exchanger 30-2 is a plate heat exchanger with an inlet conduit 31 for the external fluid circuit and an outlet conduit 32 for the fluid circuit; and an inlet conduit 34 for the heat store fluid and an outlet conduit 36 for the heat store fluid. A submersible pump 120 is provided to pump heat store fluid to the second heat exchanger 30. The inlet conduit 34 to the second heat exchanger 30 is arranged to draw heat store fluid from an upper part of the vessel, and the outlet conduit 36-1 is arranged to return heat store fluid to a lower part of the vessel. The submersible pump 120 is preferably arranged in a lower part of the vessel as it can operate better at lower temperatures. In the example illustrated in FIG. 1 the pump 35 is arranged in an upper part of the vessel at the inlet conduit 34 drawing hot heat store fluid; in the example illustrated in FIG. 6 the pump 120 is arranged at the outlet conduit 36-1 returning cooled heat store fluid to the bottom of the tank, in a lower part of the vessel in a cooler operating environment. In other examples the pump is provided outside the vessel, but by providing it inside the vessel the need for the associated conduit to pass out of and back into the vessel can be avoided. The pump 120 can be supported for example by the outlet conduit 36-2, by the heat exchanger 30-2, or by the vessel (e.g. the body 4 or the lid 2). These supports may also carry the necessary wiring to power the pump, or the wiring may be provided by a separate structure.

For attaching the pump 120 to the lid 2 or the vessel elsewise an attachment to the heat exchanger 30-2 may be provided, e.g. by the outlet conduit 36-2 for the heat store fluid (for example in case of a sufficiently robust pipe or tube), or additional brackets or other attachment mechanisms may be included attaching the pump directly to the lid 2 or to the body 4 or the vessel elsewise.

In the variant illustrated in FIG. 6 an outlet portion 122 of the outlet conduit 36-2 is angled to release outflowing cooled heat store fluid directed toward the submersible pump 120. In the illustrated example the released heat store fluid from the outlet portion 122 is downwardly directed from above the submersible pump 120, such that it can flow down past the submersible pump 120. The outlet from the outlet conduit 36-2 can be designed at a suitable distance from the submersible pump such that released fluid flows around the submersible pump. As the pump 120 discharges cooled heat store fluid from the heat exchanger 30-2 via the outlet portion 122 onto the pump 120, the cooled heat store fluid near the pump provides active cooling to the pump, reducing the possibility of overheating at the pump and detriment to the pump.

A baffle 140 may be provided to further improve stratification within the vessel 1 and help maintain a cooler region in the bottom of the vessel at the submersible pump 120. The baffle 140 is preferably located between the pump 120 and the heat exchanger 30-2. The baffle 140 is usefully provided below heat input into the thermal storage vessel 1 to promote stratification, in the illustrated example below the electric heating element 10. The baffle 140 can reduce convection and heat transfer from the heat store fluid surrounding the electric heating element to the pump 120, further ensuring the pump 120 is kept cooled. The baffle 140 is preferably made from a thermally insulating material. The baffle 140 may for example be supported by the outlet conduit 36-2, the pump 120, the outlet portion 122, the heat exchanger 30-2 or the vessel (e.g. the body 4 or the lid 2).

The operation of pump 120 can be controlled to manage the temperature of the heat store fluid flowing out of the heat exchanger 30-2. To transfer the greatest possible amount of heat at the heat exchanger 30-2 for high efficiency the pump 120 can pump at a low rate for a slow flow in the heat exchanger 30-2. The pump speed can usefully be controlled in dependence on a temperature of heat store fluid leaving the heat exchanger, and in particular to minimise that temperature and thereby to maximise the amount of heat transfer within the heat exchanger. Temperature sensors can be located within the outlet conduit 36-2, pump 120, heat exchanger 30-2 and/or outlet portion 122 to monitor fluid temperature. This information can then be fed to a controller which adjusts the flowrate of heat store fluid through the heat exchanger. This may be achieved by varying the speed of the pump 120 or controlling a valve within either outlet conduit 36-2 or inlet conduit 34. To deliver a low temperature of fluid entering the outlet conduit 36-2 the pump 120 is slowed down. The minimum pump speed is limited in an example by the minimum acceptable hot temperature at the outlet conduit 32 from the heat exchanger 30-2 into the fluid circuit. Slowing the pump 120 down beyond a threshold can result in insufficient heat transfer rate to the flow in the fluid circuit, and for example hot water delivered to a user is not warm enough. The minimum pump speed depends on the specifics of the thermal storage vessel and the wider heating system, and can be determined for a particular system topology and depending on a set of user preferences. In an example the thermal storage vessel is controlled to heat fluid to 55° C.; and the fluid circuit is to be heated to a minimum temperature of 45° C. (or less in some circumstances).

FIG. 7 shows another exemplary embodiment of the vessel 1. Many of the same features are provides as in the example illustrated in FIG. 3, however adaptations are made to assist in prevention of overheating in the submersible pumps, as discussed for the second heat exchanger 30 with reference to FIG. 6. FIG. 6 shows modifications associated with the second heat exchanger 30-2 for transferring heat from the heat store to an external fluid circuit described; in addition to those modifications, FIG. 7 shows modifications to the first heat exchanger 20-2 for providing a heat input to the vessel and the top up sub-system for optimisation of the submersible pump.

The first heat exchanger 20-2 is a plate heat exchanger with an inlet conduit 21 for the external fluid circuit and an outlet conduit 22 to the external fluid circuit; and an inlet conduit 24 for the heat store fluid and an outlet conduit 26 for the heat store fluid. A submersible pump 25-2 is provided to pump heat store fluid to the second heat exchanger 20-2. The inlet conduit 24-2 to the first heat exchanger 20-2 is arranged to draw heat store fluid from a lower part of the vessel, and the outlet conduit 26 is arranged to return heat store fluid to an upper part of the vessel. The submersible pump 25-2 is preferably arranged in a lower part of the vessel as it can operate better at lower temperatures.

An inlet portion 124 of the inlet conduit 24-2 is located and angled to draw in cool heat store fluid from around the submersible pump 25-2, so as to create a convective flow of heat store fluid around the submersible pump 25-2 and permit dispersion of heat created at the submersible pump 25-2. The inlet portion 124 of the inlet conduit 24-2 can be designed at a suitable distance from the submersible pump such that fluid drawn in flows around the submersible pump. As the pump 120 draws in cool heat store fluid from the bottom of the vessel via the inlet portion 124, the flow of heat store fluid near the pump can provide active cooling to the pump, reducing the possibility of overheating at the pump.

The baffle 140 is large enough to serve at the submersible pump 25-2 as well as the submersible pump 120, and serves to promote stratification within the vessel 1 and maintain a cooler region in the bottom of the vessel at the submersible pumps. In a variant each submersible pump 25-2 has a separate baffle above it. A second baffle 160 is arranged at the top of the vessel, to assist stratification at the top of the vessel as well. The second baffle 160 may be supported by any of conduits 26, 12 or 34, by heat exchangers 20 and/or 30, by lid 2 or body 4 or the vessel elsewise. The second baffle is preferably made from a thermally insulating material Inclusion of a baffle or baffles is optional.

The top up sub-system includes a conduit 12 and a third submersible pump 14 as described above; the conduit 12 is arranged to draw heat store fluid from a lower part of the vessel and to discharge heat store fluid in an upper part of the vessel, preferably in proximity to an electric heating element for rapid heating. In the example illustrated in FIG. 7 the conduit 12 provides no special cooling provisions for the submersible pump 14, but in a variant the conduit 12 can include an inlet portion similar to the inlet portion 124 of the inlet conduit 24-2, so as to draw in cool heat store fluid from around the submersible pump 14 as well and promote cooling at the submersible pump 14 as well. In other examples one, some or all of the pumps are provided outside the vessel, but by providing submersible pumps inside the vessel the need for the associated conduits to pass out of and back into the vessel can be avoided.

FIG. 8 shows a schematic of another exemplary embodiment of the thermal storage vessel 1. The thermal storage vessel 1 in this example is similar to the example shown in FIG. 6, with the difference being that the pump 120 is arranged in the inlet conduit 34-2 instead of the outlet conduit 36-2. The inlet conduit 34-2 is arranged to draw heat store fluid from an upper part of the vessel and to provide it the second heat exchanger 30-2, and the outlet conduit 36 returns heat store fluid to a lower part of the vessel. In order to accommodate the submersible pump 120 in a lower part of the vessel the inlet conduit 34-2 extends from an upper part of the vessel (inlet) down to a lower part of the vessel (submersible pump 120) and back up to an upper part of the vessel (second heat exchanger 30). A baffle 140 is provided similar to the other examples. An outlet portion 122 of the outlet conduit 36 is angled to release outflowing cooled heat store fluid directed toward the submersible pump 120, same as in the other examples. In FIG. 8 the outlet portion 122 is horizontally arranged and directs outflowing fluid horizontally toward the submersible pump 120, but in other examples the outlet portion 122 may be downwardly directed from above the submersible pump 120, similar to the other examples. Features may otherwise be as described with reference to FIGS. 6 and 7.

Providing the submersible pump 120 in the inlet conduit 34-2 instead of the outlet conduit 34 can be favourable to help prevent reliable functioning of the submersible pump 120. Gas bubbles formed at the submersible pump 120 can become trapped and cause reduction of the pumping performance. Arranging the submersible pump 120 downstream of the second heat exchanger 30-2 as shown in FIG. 6 can cause a greater pressure drop to occur at the submersible pump 120, and increase the risk of gas bubble formation and air lock. Providing the submersible pump 120 in the inlet conduit 34-2 upstream of the second heat exchanger 30-2 as shown in FIG. 8 can enable a lower pressure drop at the submersible pump 120, and reduce the risk of gas bubble formation and air lock. The outlet portion 122 can still provide active cooling to the pump, reducing the possibility of overheating at the pump and detriment to the pump. The inlet conduit 34-2 can optionally include additional thermal insulation to prevent undesired cooling of the fluid in the inlet conduit 34-2 prior to reaching the second heat exchanger 30-2.

While many of the illustrated examples show a cuboidal heat store, it should be appreciated that many of the features of the thermal storage vessel can be provided in other forms, such a cylinder with a domed top and bottom. FIG. 9 shows an example of a thermal store 1 with a trapezoidal cross section. Such a trapezoidal heat store can be particularly effective for installation under a staircase 200 to use dead space in a building.

Another example of a thermal storage vessel 1 is shown in FIGS. 10 to 17. FIG. 10 shows the thermal storage vessel 1 in a closed configuration, with the lid 2 shut and the heat exchangers 20, 30-2 suspended from the lid into an upper portion of the body 4 of the thermal storage vessel 1. FIG. 11 shows the internal components inside the body 4 of the thermal storage vessel 1. FIG. 12 shows the same thermal storage vessel 1 in an open configuration, with the lid 2 lifted and the heat exchangers 20, 30-2 supported above the body 4 of the thermal storage vessel 1. FIG. 13 shows the internal components in this open configuration. FIGS. 14 and 15 show the internal components inside the body 4 of the thermal storage vessel 1 in the closed and open configurations from different perspectives. FIGS. 16 and 17 show of the lid and internal components inside the body 4 of the thermal storage vessel 1 in the closed configuration, similar to FIG. 11, but from different perspectives.

The thermal storage vessels 1 illustrated in FIGS. 10 to 17 have many features in common with the thermal storage vessel described with reference to FIGS. 7 and 8, and like features are indicated with like reference numbers.

Instead of all of the internal components of the thermal storage vessel 1 depending from the lid 2 into the body 4, the illustrated examples includes some internal component that rest on a floor of the body 4 (while still being attached to the lid), and others that depend from the lid 2. In order to achieve this flexible portions 224 are included in the connections between certain of the components and the lid 2. This can be especially convenient for maintenance, as lifting the lid 2 entails lifting only some but not all of the internal components; certain of the internal components can remain resting on the floor of the body 4. In the illustrated example flexible portions are included in the connecting conduits beneath the heat exchangers 20, 30-2, such that the heat exchangers can be lifted with the lid while the components otherwise can remain resting on the floor of the body 4.

Supports can be included to facilitate supporting the lid and components once lifted from the body. In the illustrated example four tabs 222 are pivotably attached at the bottom of the heat exchangers 20, 30-2 and can be pivoted outward. In this configuration the lid 2 and heat exchangers 20, 30-2 can rest on an upper rim of the body, as shown in FIG. 12. The four tabs 222 can be pivoted inward under the heat exchangers 20, 30-2 until they no longer obstruct the assembly and the lid 2 can rest on an upper rim of the body 4 with the heat exchangers 20, 30-2 inside the body 4, as shown in FIG. 10. Different geometries and arrangements of suitable supports will be apparent. Supports may alternatively be provided on the body 4 so as to move inward into the vessel after the lid and components have been lifted out, such that the assembly can rest on the supports rather than (or in addition to) the rim of the body 4.

A first baffle 140 is arranged at the bottom of the vessel, with the submersible pumps 120, 25-2 provided below the baffle 140. The first baffle 140 can promote maintenance of a relatively colder region between the baffle 140 and the floor of the vessel, to promote formation of a suitable operating environment for the submersible pumps. A second baffle 180 is arranged in a central region of the vessel, above the baffle 140 and below the heat exchangers 20, 30-2. Optimally the second baffle is arranged such that a convenient volume of fluid can be enclosed below the second baffle and above the first baffle 140. The second baffle can promote formation of a quantity of fluid beneath the second baffle that has a more uniform temperature that it would have in the absence of the second baffle. The flow of fluid from the outlet conduit 26 beneath the second baffle can create convection currents and mixing of the water below the second baffle. Fluid above the second baffle may remain stratified such that a smaller quantity of relatively hot fluid is maintained at the top of the tank, and further down in the tank a larger volume of moderately hot fluid is formed. This can be especially useful if the external heat source is a heat pump, and on occasion instead of receiving heat from the heat pump the thermal store provides heat to the heat pump for a defrosting operation at the heat pump. The moderately hot fluid beneath the second baffle can be sufficient for such a defrosting operation while the hot fluid above the second baffle can ensure higher temperatures can also be provided e.g. for portable water heating. Appropriate positioning of the second baffle depends on factors such as vessel size, heat pump characteristics, operating environment, and desired quantities of fluid at different temperature levels.

The first heat exchanger 20 is for receiving heat from an external source, such as a heat pump, a solar panel or a boiler. The inlet conduit 24 provides a flow path of heat store fluid to the first heat exchanger 20, there to receiving heat from an external source, and then the heated fluid is returned via the outlet conduit 26. The inlet conduit 24 includes two branches: a first inlet branch 24-3 arranged to draw fluid from below the baffle 140, from the bottom of the tank; and a second inlet branch 24-4 arranged to draw fluid from above the baffle 140 and above the second baffle 180, from the top of the tank. The outlet conduit 26 is shown to return fluid to a central region of the vessel, between the baffle 140 and above the second baffle 180. A submersible pump 25-2 is provided in the first inlet branch 24-3 and another submersible pump 25-3 is provided in the second inlet branch 24-4; both submersible pumps 25-2, 25-3 are arranged below the baffle 140. The inlet to the first inlet branch 24-3 is positioned and oriented to create a flow at another submersible pump 120 below the baffle 140 as described above. Selection of one or the other branch is enabled for example by selectively switching on one or the other pump and inclusion of suitable non-return valves 228 (e.g. swing valves) in the branches. In other examples only one submersible pump is provided in the inlet conduit 24, downstream of a junction 220 of the two branches, and instead a three-port valve at the junction 220 of the two branches can be controlled to permit selection of a branch. Inclusion of the two inlet branches 24-3, 24-4 can permit selection of whether to draw fluid from a lower or upper portion of the vessel. For instance for rapidly heating a small volume at the top of the vessel the second branch can permit drawing water from the top, returning it in a central region of the vessel for it to rise to the top (due to lower density of hotter water), for it to be drawn in again at the top of the vessel for a second cycle of receiving heat. For instance for efficient heating and optimal heat transfer at the heat exchanger the first branch can permit drawing water from the bottom, where cooler, denser water collects, for more gradual heating of a larger proportion of fluid in the vessel.

A first electric heating element 10-1 is arranged above the second baffle 180 and below the heat exchangers 20, 30-2. A second electric heating element 10-2 is arranged above the baffle 140 and below the second baffle 180. The first and second electric heating elements 10-1, 10-2 can provide heating when insufficient heat is available via the first heat exchanger 20, e.g. when an external heat source is not available. This can be in particular useful if the external heat source is a heat pump or a solar panel, as these may not be capable of providing heat (e.g. at night for a solar panel) or may require a longer lead time before heat becomes available.

At the outlet conduit 32 of the second heat exchanger 30 a flow switch 226 is included. The flow switch 226 can detect water flow and start a domestic how water circuit pump, stratifying the temperature of the water.

Concerning the flexible portions 224, in the illustrated example three of the conduits 24, 34-2, 36 include flexible portions 224 between the heat exchangers 20, 30-2 and the second baffle 180. The flexible portions are flexible tubes. The flexible portions are long enough that they can permit the heat exchanger to be lifted out of the body 4 of the vessel, but not overly long to avoid overcrowding when the lid is closed. For ease of maintenance the flexible portions are attached in the conduits with fixtures that can be quickly decoupled. Between the second baffle 180 and the bottom-most features—the pumps 25-2, 25-3, 120 and the diffuser 38—the conduits are rigid. The second baffle 180 is attached to certain of the conduits such that the second baffle 180 can be supported by the conduits within the vessel 1. The lower baffle 140 can similarly be attached to certain of the conduits such that it can be supported within the vessel 1. Certain of the conduits—e.g. the outlet conduit 26 for releasing heated fluid—neither include a flexible portion nor are attached to the second baffle 180; instead the outlet conduit 26 can slide through an aperture in the second baffle 180. The inlet conduit 34-2 to the second heat exchanger 30-2 and the second inlet branch 24-4 to the first heat exchanger 20 include rigid conduit portions that extend above the second baffle 180.

In an alternative the flexible portions are included elsewhere. For instance the flexible portions may be provided between the second baffle 180 and the lower baffle 140. In this variant if an upper electric heating element 10-1 is included it can be arranged below the second baffle 180, or the second baffle can include an opening to permit the second baffle to be lifted up past the first electric heating element 10-1. In another variant the flexible portions may be provided between the heat exchangers 20, 30-2 and the lid 2.

While many of the illustrated examples show components attached to the lid of the thermal store, it will be appreciated that in some examples components may be attached in the thermal store elsewise, e.g. with rigid tubes embedded in a side wall, with brackets attached to a side wall or resting in a depression in a bottom surface.

While many of the illustrated examples are concerned with a polymeric vessel it will be appreciated that many of the features can be provided in vessels of or including other materials. While many of the illustrated examples are concerned with a vessel having a lid and body, it will be appreciated that many of the features can be provided in other vessels.

While not illustrated, a temperature reduction valve may be provided at the second heat exchanger 30 for transferring heat from the heat store to an external fluid circuit. The valve acts to reduce the temperature of the water leaving the heat exchanger via the outlet conduit 32 to the fluid circuit. This is achieved by mixing cooler incoming water from the inlet conduit 31 to the outlet conduit 32, thereby lowering the temperature of the water. The mixing can be controlled electronically with an external controller, or mechanically by a thermostat. This can permit the heat store to heat water to a relatively high temperature, higher than might be preferred for user hot water provision (where scalding is undesirable), and ensure that hot water provided to a user is mixed to an appropriate temperature. The temperature reduction valve may be electronically controlled (for instance consisting of an actuator and a valve) in which the valve stays shut (separating the two streams) until the controller opens the valve and allows cool water to mix with the hot water. The valve may otherwise be mechanically controlled e.g. by a thermostat akin to an internal combustion thermostat in which a valve opens under spring pressure at a pre-set temperature, allowing the passage of water through the valve. Such a temperature reduction valve may be provided with any of the examples illustrated and described in detail above.

While not illustrated, a vent pipe extending to an expansion tank or venting to atmosphere is typically included, as is well known for such vented heat stores. The vent pipe advantageously is arranged to draw fluid from the bottom of the vessel for the purposes of minimising heat losses.

While not illustrated, one or more phase change material compartment may be included in the vessel. These compartments contain a phase change material such as paraffin wax that can melt and solidify within the compartment due to heat transfer between the material and water within the vessel volume. The compartments are preferably made from copper. The compartments can be suitably held in position. Phase change material compartments can be included in the thermal store to increase the total amount of energy storage potential.

While not illustrated in all of the examples, an array of temperature sensors is typically included. An array of temperature sensors can permit detection of the state of thermal stratification of heat store fluid in the vessel, which can give an indication of the heat available for use from the thermal store, depending on the thermal profile. Individual temperature sensors can be provided, for example to control operation of a component such as a submersible pump or a valve.

While many of the illustrated examples include one heat exchanger for providing heat to the thermal store and one heat exchanger for drawing heat from the thermal store, it should be appreciated that fewer or more heat exchangers may be included. For instance one heat exchanger may be provided for drawing heat for heating potable water, and another heat exchanger may be provided for drawing heat for space heating. The heat exchanger for providing heat to the thermal store may be omitted in favour of one or more electric heating elements for providing heat to the thermal store. One heat exchanger may be provided for providing heat from a first source (e.g. a heat pump) and a second heat exchanger may be provided for providing heat from a second source (e.g. a solar heating system). It should also be appreciated that none, one, or more electric heating elements may be included.

Various other modifications will be apparent to those skilled in the art.

For example, while the illustrations show examples where the lid extends over the entire top surface of the vessel, it should be appreciated that the lid may extend over only a portion of the top surface of the vessel. For example, a flange or rim may be provided around the lid in the upper surface. In other examples the lid may extend from the top surface of the vessel to form part of one or more of the side surfaces of the vessel. While many of the examples described above focus on vessels with a lid and a body, it should be recognised that the internal components and arrangements can generally be provided in other vessels. While some of the examples described above focus on a thermal storage vessel with components attached to the lid, it should be recognised that some or all of the components can be attached otherwise, in a vessel with or without lid, e.g. to the body of the vessel or to a side or bottom or top of the vessel otherwise, or certain of the components may be provided without an attachment (e.g. a temperature sensor array).

While the examples described above focus on cuboid vessels, it should be recognised that the described thermal storage vessel can be provided in other forms, such as cylindrical.

The vessel described herein could similarly be used with other suitable heat storage materials, for example phase change materials or aqueous solutions or mixtures or non-aqueous liquids or other fluids.

While the examples described above mostly consider domestic heating systems, it should be recognised that the described thermal storage vessel can be used for thermal storage in other settings and systems.

While the removable lid is shown as being completely detachable from the body, it should be understood that in some variants the removable lid may remain partially attached to the body after opening the lid. For example a hinged lid may be provided instead of the illustrated fully detachable lid.

Where the upper part of the vessel is referred to, it should be appreciated that this may include near the top of the vessel, an upper portion of the vessel, a top portion of the vessel, a top half, third or quarter of the vessel (by volume or by height), with the vessel in such orientation as it is intended to be installed for use. Where the lower part of the vessel is described, it should be appreciated that this may include near the bottom of the vessel, in a lower portion of the vessel, or in a bottom half, third or quarter of the vessel (by volume or by height), with the vessel in such orientation as it is intended to be installed for use.

While a plate heat exchanger is described in the examples above, it will be appreciated that other types of heat exchangers may be used instead, such as a shell and tube heat exchanger. Generally the heat exchanger provides conduits for two forced flows with the conduits arranged such that heat is transferred across conduit walls from one of the flows to the other flow.

It will be understood that any of the sub-assemblies or components described herein may be used in any number and combination. It will be understood that the present invention has been described above purely by way of example, and modifications of detail can be made within the scope of the invention.

Reference numerals appearing in the claims are by way of illustration only and shall have no limiting effect on the scope of the claims.

The term ‘comprising’ as used in this specification and claims preferably means ‘consisting at least in part of’.

1. A thermal storage vessel for containing a heat store fluid for receiving or delivering heat and at least one heat exchanger arranged inside the vessel, wherein the at least one heat exchanger provides conduits for two forced flows with the conduits arranged such that heat is transferred across conduit walls from one of the flows to the other flow.

2. A thermal storage vessel according to claim 1, wherein the at least one heat exchanger is a plate heat exchanger or a shell and tube heat exchanger.

3. A thermal storage vessel according to claim 1 or 2, wherein the at least one heat exchanger is arranged in an upper part of the thermal storage vessel, preferably at or near a top of the thermal storage vessel.

4. A thermal storage vessel according to any preceding claim, wherein the thermal storage vessel includes a body and a lid and the at least one heat exchanger is attached to the lid.

5. A thermal storage vessel according to any preceding claim, further comprising at least one pump arranged to pump heat store fluid to the at least one heat exchanger.

6. A thermal storage vessel according to claim 5, wherein the at least one pump is arranged inside the vessel.

7. A thermal storage vessel according to claim 5 or 6, wherein the pump is a submersible pump.

8. A thermal storage vessel according to any one of claims 5 to 7, wherein the pump is arranged in a lower part of the thermal storage vessel.

9. A thermal storage vessel according to any one of claims 5 to 8, wherein the pump is arranged near an outlet of a discharge conduit of the pump and the discharge conduit is arranged to discharge fluid toward the pump.

10. A thermal storage vessel according to any one of claims 5 to 9, wherein the pump is arranged near an inlet of a feed conduit for the pump and the feed conduit is arranged to draw in fluid from around the pump.

11. A thermal storage vessel according to any one of claims 5 to 10, wherein the pump is a variable speed pump to adjust the flow of heat store fluid from the vessel into the heat exchanger.

12. A thermal storage vessel according to any one of claims 5 to 11, wherein the pump is arranged upstream of the heat exchanger.

13. A thermal storage vessel according to any one of claims 5 to 12, further comprising one or more baffles arranged above the pump and preferably beneath a location in the thermal storage vessel where heat is provided to the thermal storage vessel.

14. A thermal storage vessel according to any preceding claim, comprising a baffle or a further baffle arranged beneath the at least one heat exchanger.

15. A thermal storage vessel according to any preceding claim, comprising one or more further components arranged inside the vessel and attached to the at least one heat exchanger, wherein an attachment between the one or more further components and the at least one heat exchanger comprises a flexible portion.

16. A thermal storage vessel according to claim 15, wherein the attachment is a conduit.

17. A thermal storage vessel according to claim 15 or 16, wherein the attachment comprises a rigid portion for arrangement in a lower part of the thermal storage vessel and the flexible portion for arrangement in an upper part of the thermal storage vessel.

18. A thermal storage vessel according to any one of claims 15 to 17, wherein the flexible portion is for arrangement at and/or beneath the at least one heat exchanger.

19. A thermal storage vessel according to any one of claims 15 to 18, wherein in an extended configuration of the flexible portion the at least one heat exchanger is removable from the thermal storage vessel without moving the one or more further components.

20. A thermal storage vessel according to any one of claims 15 to 19, wherein the or a rigid portion of the attachment is rigidly attached to one or more of the further components, preferably for arrangement in a lower part of the thermal storage vessel, optionally for resting on a floor of the thermal storage vessel.

21. A thermal storage vessel according to any one of claims 15 to 20, wherein the one or more further components is at least one of: a pump, a diffuser, and a baffle.

22. A thermal storage vessel according to any preceding claim, wherein the thermal storage vessel or a body of the thermal storage vessel is formed of a polymer.

23. A thermal storage vessel according to any preceding claim, wherein the thermal storage vessel is cuboid or trapezoidal.

24. A thermal storage vessel according to any preceding claim, wherein the heat store fluid is water or an aqueous solution.

25. A thermal storage vessel according to any preceding claim, further comprising an array of temperature sensors arranged to sense temperatures at different heights in the vessel.

26. A thermal storage vessel according to any preceding claim for containing heat store fluid at ambient pressure.

27. A thermal storage vessel according to any preceding claim, comprising a first and a second heat exchanger, wherein the first heat exchanger is for receiving heat at the thermal storage vessel from an external heat source; and the second heat exchanger is for delivering heat from the thermal storage vessel to an external fluid circuit.

28. A thermal storage vessel according to claim 27, wherein the external heat source is a heat pump or a solar heating system.

29. A thermal storage vessel according to claim 27 or 28, wherein the external fluid circuit is a circuit of mains pressurized water or a circuit of fluid for a space heating system.

30. A thermal storage vessel according to any preceding claim further comprising at least one tab arranged to protrude in a first configuration and withdraw in a second configuration and further arranged to support the at least one heat exchanger relative to the thermal storage vessel in the first configuration and to release the at least one heat exchanger relative to the thermal storage vessel in the second configuration.

31. A thermal storage vessel according to claim 30, wherein at least one tab is pivotably attached at an underside of the at least one heat exchanger or pivotably attached at a rim of the thermal storage vessel.

32. A thermal storage vessel according to any preceding claim, wherein the at least one heat exchanger is for receiving heat from an external heat source; and wherein a conduit for providing heat store fluid to the at least one heat exchanger is arranged to draw fluid from a lower portion of the thermal storage vessel.

33. A thermal storage vessel according to any preceding claim, wherein the at least one heat exchanger is for receiving heat from an external heat source; and wherein a conduit for providing heat store fluid to the at least one heat exchanger includes a first branch arranged to draw fluid from a lower portion of the thermal storage vessel and a second branch arranged to draw fluid from an upper portion of the thermal storage vessel.

34. A thermal storage vessel according to claim 33 further comprising a first pump in the first branch and a second pump in the second branch and preferably a non-return valve in each branch.

35. A thermal storage vessel according to claim 33 further comprising a valve at the junction of the first and second branch for selection of the first or second branch.

36. A thermal storage vessel according to any preceding claim, wherein the at least one heat exchanger is for receiving heat from an external heat source; and wherein a conduit for returning heat store fluid from the at least one heat exchanger is arranged to release fluid in an upper or central portion of the thermal storage vessel.

37. A thermal storage vessel according to any preceding claim, wherein the at least one heat exchanger is for receiving heat from an external heat source; and further comprising a diverter valve arranged to provide a flow path from the heat exchanger either to an upper portion of the thermal storage vessel or to a central or lower portion of the thermal storage vessel.

38. A thermal storage vessel according to any preceding claim, wherein the at least one heat exchanger is for delivering heat from the thermal storage vessel to an external fluid circuit; and wherein a conduit for providing heat store fluid to the at least one heat exchanger is arranged to draw fluid from an upper portion of the thermal storage vessel.

39. A thermal storage vessel according to any preceding claim, wherein the at least one heat exchanger is for delivering heat from the thermal storage vessel to an external fluid circuit; and wherein a conduit for returning heat store fluid from the at least one heat exchanger is arranged to release fluid in a lower portion of the thermal storage vessel.

40. A thermal storage vessel according to any preceding claim, further comprising a top-up system including an electric heating element arranged in an upper part of the thermal storage vessel, a pump and a conduit arranged to draw heat store fluid from a lower part of the thermal storage vessel to the electric heating element.

41. A thermal storage vessel according to any preceding claim, further comprising a heat store fluid supply conduit for providing heat store fluid into the thermal storage vessel and a float valve arranged to close the heat store fluid supply conduit at a predetermined vessel fill level.

42. A heating system comprising a thermal storage vessel according to any preceding claim.

43. A heating system according to claim 42 further comprising one or more of:
a controller arranged to control the components of the heating system including the components of the thermal storage vessel;
a heat source, preferably a heat pump, arranged to deliver or receive heat to or from the thermal storage vessel;
a diverter valve for diverting heat from the heat source to the thermal storage vessel or from the thermal storage vessel to another subsystem;
a circuit of mains pressurized water arranged to receive heat from the thermal storage vessel; and
a space heating system with a circuit of fluid arranged to receive heat from the thermal storage vessel.

44. A kit of parts for a thermal storage vessel for containing a heat store fluid for receiving or delivering heat, the kit including a body and a lid; and at least one heat exchanger for arrangement inside the vessel, with the heat exchanger having conduits for two forced flows with the conduits arranged such that heat is transferred across conduit walls from one of the flows to the other flow, for arrangement of the heat exchanger inside the vessel.

45. A kit of parts according to claim 44, wherein the parts are for a thermal storage vessel according to any of claims 1 to 41.

46. A method of heating fluid comprising providing the fluid to a thermal storage vessel according to any of claims 1 to 41.

47. A thermal storage vessel for containing a heat store fluid for receiving or delivering heat, the thermal storage vessel preferably including a body and a lid; and at least one heat exchanger, preferably attached to the lid, for arrangement of the heat exchanger inside the thermal storage vessel.

48. A thermal storage vessel according to claim 47 comprising the features of any one of claims 1 to 41.
